(19) United States
(12) Patent Application Publication
(10) Pub. No.: US 2022/0192113 A1
(43) Pub. Date: Jun. 23, 2022

(54) Gas Diffusion System for Agriculture

(71) Applicants: Kyle Barker, Surrey (CA); Abid Shah, Burnaby (CA); Paul Brandner, Surrey (CA); Adam Fishman, Langley (CA)

(72) Inventors: Kyle Barker, Surrey (CA); Abid Shah, Burnaby (CA); Paul Brandner, Surrey (CA); Adam Fishman, Langley (CA)

(21) Appl. No.: 17/128,017

(22) Filed: Dec. 19, 2020

(51) Int. Cl. A01G 31/02; C02F 1/72; C02F 1/68; B01F 3/04

(52) U.S. Cl. CPC A01G 31/02; C02F 1/727; C02F 1/68; B01F 2215/0009; B01F 2003/04879; B01F 2003/04893; B01F 3/04248

(57) ABSTRACT

In agriculture, one of the most important issues is the extent to which the yield of high-quality crops can be increased while saving labor and reducing costs. However, there are many problems in that so-called injuries of crops due to continuous cropping and other causes seriously reduce productivity. The present invention provides an apparatus and a method that provides a method of feeding plants CO₂ on foliage or O₂ on roots by way of injecting a gas into a liquid such that the bubbles formed are of a size that allows them to remain suspended in the liquid for up to two days without dissolving into the liquid thus allowing the system to use the liquid with the suspended bubbles as a foliar or root spray or as a liquid for use in a hydroponic growing system.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to an apparatus for infusion of nano sized CO₂ or O₂ bubbles into water through a diffusion process for feeding/plant grow is designed. This approach is useful in any agricultural setting from vegetables, flowers, tree saplings, cannabis and algae.

### Description of the Related Art

One of the most important issues in agriculture is the yield of high-quality agriculture crops that can be obtained while minimizing labor and reducing costs. However, many farmers tend to repeatedly cultivate the same kind of plant in the same agricultural field, depending upon the climate and for economic reasons. As a result, damage from nematodes, soil pathogenic microorganisms, and other factors may cause some significant problems relating to a seriously reduced productivity from so-called injuries of crops due to continuous cropping, poor soil fertility, and the like.

There are multiple existing models in similar field which have provided advancements in multiple ways. The existing models of Spray Systems are complex and have invasive pricing. Moreover, a complex spray set up often required. The existing models also lack versatility for multiple types of crops and can only be used for indoor growing in greenhouses whereas this system can be used indoors or outdoors.

Another model which is conventionally used Carbon dioxide gas system. The High CO2 emissions have a negative environmental impact and result in increased cost to grower due to government penalties. Also, an overly complex system with many moving parts is deployed which requires much expertise. The highly inefficient delivery of CO2 can also lead to unexpected outcomes. Furthermore, it is hazardous to greenhouse teams.

Therefore, there remains a need for a new and improved design for a simple and most efficient CO2 or O2 injection system to increase grower yield.

There are multiple solutions that have been presented in prior art. However, these solutions are limited and restricted to their conventional systems. As a result of intensive studies on the above problems, the present inventor has found that the above problems can be solved by a novel method of feeding plants CO₂ on foliage or O₂ on roots by way of injecting a gas into a liquid such that the bubbles formed are of a size that allows them to remain suspended in the liquid for up to two days without dissolving into the liquid thus allowing the system to use the liquid with the suspended bubbles as a foliar or root spray or as a liquid for use in a hydroponic growing system or as a part of an irrigation system in outdoor growing.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a simplest and most efficient CO₂ or O₂ injection system to increase grower yield.

It is also the primary objective of the invention to provide specifically method of feeding plants CO₂ on foliage or O₂ on roots by way of injecting a gas into a liquid such that the bubbles formed are of a size that allows them to remain suspended in the liquid for up to two days without dissolving into the liquid thus allowing the system to use the liquid with the suspended bubbles as a foliar or root spray or as a liquid for use in a hydroponic growing system or for use in an irrigation system.

It is another objective of the invention to provide a direct application of water with CO₂ onto the leaves of plants which increases yields and decreases growing time.

Another object of the present invention is to provide a plant presentation watering system that may balance needs to promote good plant health with easy watering schedules, e.g., once a week, once every two weeks, and the like.

Another object of the present invention is to provide a direct application of water with O₂ onto the roots of plants increases yields and decreases growing time.

It is further the object of invention to provide a system which integrates easily into any existing watering system.

It is further object of the present invention is to provide a technology where water main simply plugs into the Yieldx box.

It is also the objective of the invention to provide a smart assembly which provide ease of use and convenience to the user and no need to change in existing irrigation systems is required.

It is also the objective of the invention to provide an efficient and easy system which is cost effective and convenient

It is furthermore the objective of the invention to provide assembly where Micro bubbles containing CO2 remain in water line for up to two days.

Thus, it is the objective to provide a gas diffusion system which is convenient approach for planting and raising plants of any type in any arrangement. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 shows the gas diffusion system in its non-operative form as per its preferred embodiments of the invention.

FIG. 2 shows the gas diffusion system in its operative form as per preferred embodiments of the invention.

FIG. 3 shows the assembly operational parts as per preferred embodiments of the invention.

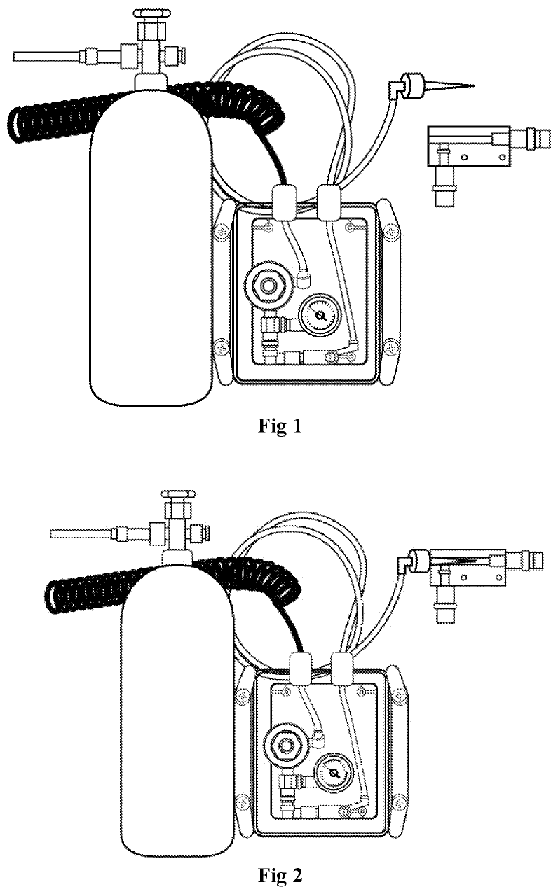

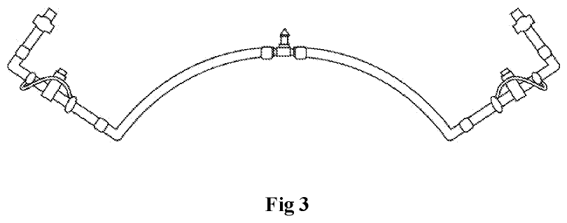

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides a novel method of feeding plants CO₂ on foliage or O₂ on roots by way of injecting a gas into a liquid such that the bubbles formed are of a size that allows them to remain suspended in the liquid for up to two days without dissolving into the liquid thus allowing the system to use the liquid with the suspended bubbles as a foliar or root spray or as a liquid for use in a hydroponic growing system.

The invention as per its preferred embodiments works in following way where a source for a compressed gas (could be a compressor, a tank or any other method of compressing a gas to a minimum of 2 psig to a maximum of 350 psig. A diffuser element which works as both a barrier between the gas and liquid and also allows the gas to pass through fissures in the diffuser material and form bubbles in the liquid.

A casing that embodies a passage for the liquid and a holder for the diffuser which places the diffuser in the path of the flow of the liquid. A method to carry the liquid from a source to the casing mentioned above. This method may be via a pump, gravity fed system or any other method of carrying a liquid with sufficient pressure and volume to flow over the diffuser in the casing.

A method for spraying the liquid onto the leaves of the plant in a standard method of agriculture with the plants growing in soil or onto the leaves of the plant in a hydroponic method of growing or onto the roots of the plant in an Aeroponic method of growing or in any combination of these methods of growing.

The inventions principally work in following manner where Water is fed via a pipe to a fitting on the Casing body. The Gas is fed to the diffuser via a fitting on the rear of the Casing body. The gas is routed through a pressure regulating device then through a device to control volume, or a combination of the two devices, to ensure the correct pressure is maintained to form the required size of bubbles.

The Gas as per its further embodiments passes through the diffuser body to the outer surface of the diffuser element where bubbles form. Due to the volume of the liquid flow, the pressure of the liquid flow relative to the pressure of the gas being fed to the diffuser, the bubbles that form are of a specific size to achieve the goal of keeping the bubbles suspended in the liquid without dissolving into the liquid and without rising to the surface of the liquid and dissipating into the surrounding atmosphere.

If the bubbles are comprised of CO₂, they are then fed via smaller pipes or tubes terminating with spray nozzles, to be sprayed, from any direction, onto the leaves of the plant. Furthermore, if the bubbles are comprised of O₂, they are then fed via smaller pipes or tubes terminating with spray nozzles, to be sprayed, from any direction, onto the roots of the plant.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A universal eco-friendly and an ergonomic design of Gas Diffusion System for Agriculture comprising:
a source for a compressed gas which can be a compressor, a tank or any other method of compressing a gas to a minimum of 2 psig to a maximum of 350 psig;
a diffuser element to act as a barrier between the gas and liquid;
a diffuser element allowing the gas to pass through fissures in the diffuser material and form bubbles in the liquid;
a casing which embodies a passage for the liquid and a holder for the diffuser which places the diffuser in the path of the flow of the liquid;
a method to carry the liquid from a source to the casing where the method may be via a pump, gravity fed system or any other method of carrying a liquid with sufficient pressure and volume to flow over the diffuser in the casing; and
a method for spraying the liquid onto the leaves of the plant in a standard method of agriculture with the plants growing in soil or onto the leaves of the plant in a hydroponic method of growing or onto the roots of the plant in an Aeroponic method of growing or in any combination of these methods of growing.
